(19) United States
(12) Patent Application Publication
(10) Pub. No.: US 2006/0129928 A1
(43) Pub. Date: Jun. 15, 2006

(54) Use of pointing device to identify ideographic characters

(76) Inventor: Weigen Qiu, Calgary (CA)

Correspondence Address: HODGSON RUSS LLP, ONE M & T PLAZA, SUITE 2000, BUFFALO, NY, 14203-2391, US

(21) Appl. No.: 11/291,331

(22) Filed: Nov. 30, 2005

Related U.S. Application Data
(60) Provisional application No. 60/632,370, filed on Dec. 2, 2004.

(51) Int. Cl. G06F 17/21

(52) U.S. Cl. 715/535

(57) ABSTRACT

The invention includes methods and devices for selecting an ideographic character. A pointing device may be used to select a pinyin character, then one of more pinyin-groups and finally an ideographic character.

### CROSS-REFERENCE TO RELATED APPLICATION

This application claims the benefit of priority to U.S. provisional patent application serial No. 60/632,370, filed on Dec. 2, 2004.

### FIELD OF THE INVENTION

The present invention relates to devices and methods of identifying ideographic characters.

### BACKGROUND OF THE INVENTION

Users of mobile appliances are often limited in how they are allowed to generate inputs. This is predominantly because mobile appliances have small keypads and small screens. Keypads often have a plurality of letters or equivalent symbology associated with each key. For example, many telephone keypads associate one of the keys with the number “2”, and also with the letters “a”, “b” and “c”. Software may be used to decode which of the symbols is intended by a press of a key. Often, the software uses a statistical or a deterministic model to decode key presses.

Another method of selecting symbols uses a display coupled with a pointing device. One such pointing device is a joystick, which may be used to identify a symbol provided on the display. Symbols may be selected one-by-one from a palette of possible candidate symbols. The selected symbols are shown on the display so the user can view his efforts to assemble a word. More sophisticated methods attempt to offer completed words as a candidate before all the letters of the desired word have been selected.

The Chinese language is exceptionally rich in characters, having some fifty thousand. Interestingly, the language is highly homophonic, and a single sound can be any of several ideographic characters. The intended character is generally resolved by the listener in the context of what is being said.

Pinyin is a process by which a person may spell, using Roman letters, the sound emitted when pronouncing an ideographic character. When ideographic characters are being sought using pinyin entry, there is no inflection information, and so a single pinyin entry may correspond to more than one ideographic character. Thus the entire set of Chinese characters may be indexed by some 400 pinyin words. Having 400, rather than 50,000 characters, simplifies entry of such symbols. However, further simplification is needed in order to allow faster selection of symbols.

### SUMMARY OF THE INVENTION

The present invention includes methods and devices which may be used to identify an ideographic character. For example, in a method according to the invention, a pointing device may be used to assemble ideographic messages, such as the Chinese Hanzi, using the Roman alphabet pinyin entry. The present invention may reduce the effort necessary to select symbols using a pointing device. Further the present invention may permit the user to create messages by entering character sequences using only one hand.

In a method of using a pointing device to identify an ideographic character, an appliance may be provided. The appliance may have a pointing device and a display. A first list of pinyin-character candidates may be provided on the display, and a user may select a first pinyin character from the first list using the pointing device. A second list may be provided. The second list may be comprised of pinyin-group candidates, each pinyin-group candidate starting with the selected first pinyin character. A desired pinyin-group may be selected from the second list, and an ideographic character associated with the desired pinyin-group may be provided on the display.

A device according to the invention may include a display, a pointing device, and a microprocessor in communication with the pointing device and the display. The microprocessor may be programmed to (a) provide via the display a first list of pinyin-character candidates, (b) receive a first selection from the pointing device, the first selection being one of the pinyin-character candidates, (c) provide via the display a second list, the second list being comprised of pinyin-group candidates, each pinyin-group candidate starting with the first selection, (d) receive a second selection from the pointing device, the second selection being one of the pinyin-group candidates; (e) providing via the display an ideographic character associated with the selected pinyin-group.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which illustrates a method according to the invention; and

FIG. 2, which is a schematic depiction of devices according to the invention.

### FURTHER DESCRIPTION OF THE INVENTION

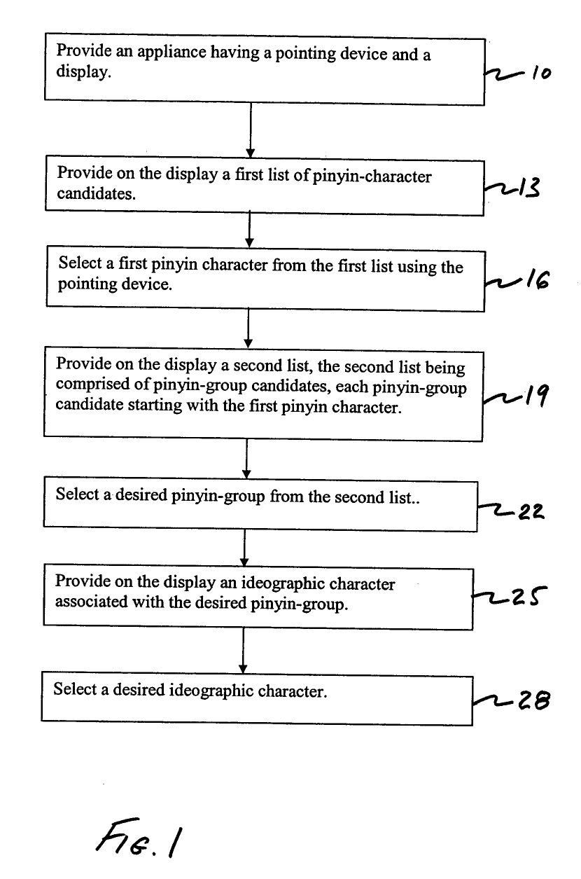

The invention may be embodied as a method. FIG. 1 depicts one such method, in which a pointing device may be used to identify an ideographic character. The method may begin by providing 10 an appliance having a pointing device and a display. The pointing device may include a user-interface device, such as a track ball or a joystick which are common among computer video games. The display may use a liquid crystal display or light emitting diodes, which are common on cell-phones.

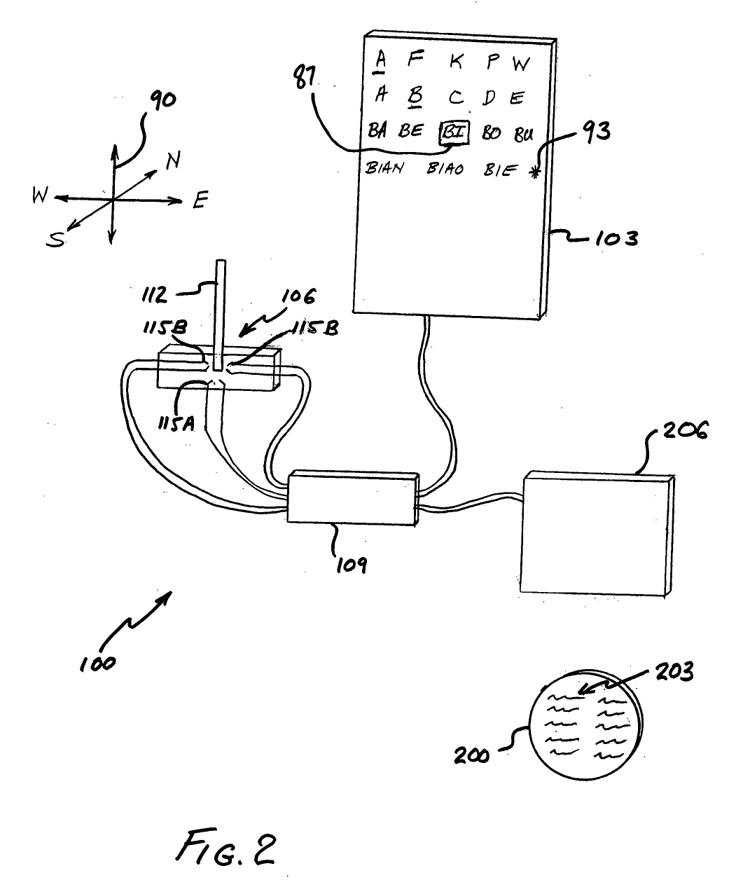

When a user initiates either the creation or editing of a text string, the insertion point may be defined by default to be the end of the existing string, or selected by the user by moving a cursor 87 on the display. See FIG. 2. In the event that the text string is empty, as in the creation of a new message, the next logical step would be for the user to begin entering data, and so movement of the cursor 87 at this time may only represent a request to seek data. If the existing text string is not empty, then the user may request that data be placed at the insertion point. In this example, depressing the pointing device may select this option and the next movement of the joystick may begin to identify data.

A first list of pinyin-character candidates may be provided 13 via the display to the user. For example, the letters “A”, “F”, “K”, “P” and “W” may be provided via a display. By moving the cursor 87 on the display, the user may place the cursor 87 on one of these initial pinyin-character candidates and be provided with that pinyin-character candidate as well as pinyin-character candidates that follow. So, for example, if the cursor 87 is placed on the “A”, the user may be provided 13 with “A”, “B”, “C”, “D” and “E”. Because not all of the Roman letters may identify a character, some of the Roman letters may not be provided 13 to the user. For example, if the cursor 87 is placed on the “F”, the user may be provided 13 with “F”,“G”, “H” and “J”.

In a similar fashion, by moving the cursor 87 so as to indicate “K”, the user might be provided 13 with the pinyin-character candidates “K”, “L”, “M”, “N” and “O”. Indicating “P” might result in the user being provided 13 with the pinyin-character candidates “P”, “Q”, “R”, “S” and “T”. Finally, indicating “W” might result in the user being provided 13 with pinyin-character candidates “W”, “X”, “Y” and “Z”.

By moving the cursor 87 to a desired pinyin-character candidate, the user may then select 16 that desired pinyin-character candidate, for example, by applying downward pressure on (“depressing”) the pointing device or applying a force in a southerly direction. In FIG. 2, the direction of motion when depressing and releasing the pointing device is indicated by the arrow 90. Once a pinyin character has been selected 16, the user may be provided 19 via the display with a second list. The second list may have pinyin-group candidates which each start with the selected pinyin character. For example, if the selected pinyin-character candidate is “A”, the corresponding pinyin-group candidates provided 19 to the user may be “A”, “AI”, “AN” and “ANG”. Notice that one of the pinyin-group candidates may also be among the list of pinyin-character candidates—in this example the “A” appeared in both the list of pinyin-character candidates and the list of pinyin-group candidates.

As another example, if the user moved the cursor 87 so as to identify and then select 16 the “B” pinyin-character candidate, the user might be provided 19 with the corresponding pinyin-group candidates, namely “BA”, “BE”, “BI”, “BO” and “BU”. The user may then point to one of these pinyin-group candidates, for example by moving the cursor 87 so as to highlight a desired one of the pinyin-group candidates, and be provided 25 with ideographic characters, another list of pinyin-group candidates, or both. For example, if the user used the cursor 87 to highlight “BA”, the user might be provided with “BAI”, “BAN”, “BANG”, “BAO” and “BA”. The repetition of “BA” is not strictly necessary in that it might be possible to generate ideographic candidates corresponding to “BA”, but the user may prefer seeing only pinyin-group candidates, rather than mixing pinyin-group candidates with ideographic characters.

Also, it should be noted that it is not necessary to proceed with each pinyin-group level showing pinyin-groups having only one more letter appended to the preceding element. To illustrate this point, in the foregoing example, upon selecting the pinyin-group “BA” from the first level of pinyin-group candidates, the user was provided with “BANG” in addition to “BAN.

In the foregoing example, the user selected 22 the pinyin-group “BA” and was provided with a second level of pinyin-group candidates. The user might then place the cursor 87 so as to identify one of these pinyin-group candidates, and be provided 25 with ideographic characters corresponding to the identified pinyin-group candidate. However, if the user had moved the cursor 87 so as to identify and then select 22 the pinyin-group “BO” or “BU”, then only ideographs might be provided to the user, since the “BO” and “BU” pinyin-groups lead only to ideographic characters. In either instance, the end result is that the user is provided 25 with ideographic characters after selecting one or more pinyin-groups. Selection 28 of an ideographic character may be accomplished by moving the cursor 87 to highlight the desired ideographic character and then depressing the pointing device.

In an embodiment of the invention, selection 16, 22 of a pinyin-character candidate or pinyin-group may be made by either depressing the user-interface device or by applying a force to the user-interface device in a southerly “S” direction. In that embodiment, depressing the user-interface device will result in only ideographic characters being displayed. However, if the user applies a southerly “S” force to the user-interface device, then only pinyin-group candidates are displayed, unless there are no further pinyin-group candidates to display, in which case only ideographic characters would be displayed for selection 28 by the user. In such an embodiment of the invention, had the user selected 22 the pinyin-group “BA” by depressing the user-interface device, the user would not have been provided with the pinyin-group candidates “BAI”, “BAN”, “BANG”, “BAO” and “BA”, and instead would have been provided 25 with ideographic characters. Those ideographic characters might have been limited to characters corresponding to “BA”, or might have been the set of characters corresponding to “BAI”, “BAN”, “BANG”, “BAO” and “BA”.

In some cases, the pinyin group having the same first two letters can be quite long. Where the available display space is limited, only part of the group may be provided at one time. As an example, consider the pinyin group beginning with “BI”, which comprises “bian”, “biao”, “bie”, “bin”, “bing” and “bi”. Since there must be a space between each word displayed, at least twenty-five character positions are needed on a screen to show these on a single line. If a screen is too small to provide these simultaneously, then only as many as can fit are provided, and an indicator 93 may be given so that the user will know there are more candidates that are hidden from view. To display the hidden candidates, the cursor 87 may be shifted in the direction of the hidden candidates until they are scrolled into view. When larger screens are available, this difficulty will not arise, and it is possible to show the entire candidate set as one group.

Because of the large number of “same sound” characters, providing 25 ideographic candidates is almost certain to overfill a display line. Ideographic candidates may be provided 25 with regard to the likelihood of use. If the candidate is not associated with prior entered text (for example the start of a new word or phrase) then candidates may be provided 25 in frequency order, based either upon raw frequency of occurrence or on some modified frequency. In the case that associations are possible, the best associated characters may be provided 25 before unassociated characters. In the same way as for the pinyin group described above, the cursor 87 may be scrolled or stepped until selection is achieved. Selection 28 of an ideograph may move the ideograph to the insertion point in the text creation or edit line on the display.

In an embodiment of the invention, if the user moves the cursor 87 to identify a pinyin character or pinyin-group, the corresponding next level of information may be provided in a lower portion of the display so that the user is permitted to view the candidates that will be provided 19, 25 should the user select the item identified by the cursor 87. In this manner, the user may be assisted in selecting an item that is most likely to yield a pinyin-group or ideographic character desired by the user.

The pinyin-group candidates may be provided 19 in alphabetical order, in an order corresponding to the likelihood of being selected, or some other order desired by the user. For example, if the pinyin-group candidates are provided 19 in an order corresponding to the likelihood of selection, previously entered text may be used to predict which of the pinyin-group candidates is most likely to be selected next. In a similar manner, ideographic candidates may be provided 19 in an order corresponding to the likelihood of being selected, and the likelihood of being selected may be based on previously entered text.

The order of providing 19, 25 pinyin-group candidates and/or ideographic characters may be based on phrases or words that the user may be trying to input. For example, it may be possible to predict phrases desired by the user and cause these to appear in one portion of the display, while predicted words that the user may be trying to input may appear in another portion of the display. In this manner, the user may be afforded the opportunity to select from a list of predicted phrases or words before the components of those phrases or words have been painstakingly identified and selected.

The invention may be embodied as a selection device 100. Such a selection device 100 may be part of a cell-phone, personal digital assistant or other mobile appliance. In one embodiment according to the invention, the selection device 100 includes a display 103, a pointing device 106, and a microprocessor 109 that is in communication with the pointing device 106 and the display 103. The microprocessor 109 may be programmed to carry out a method according to the invention. For example, the microprocessor 109 may be programmed to (a) provide via the display 103 a first list of pinyin-character candidates, (b) receive a first selection from the pointing device 106, the first selection indicating one of the pinyin-character candidates, (c) provide via the display 103 a second list, the second list being comprised of pinyin-group candidates, each pinyin-group candidate starting with the first selection, (d) receive a second selection from the pointing device 106, the second selection indicating one of the pinyin-group candidates; and (e) provide via the display 103 an ideographic character associated with the selected pinyin-group.

The pointing device 106 may include a user-interface device 112, such as a track ball or joystick. The pointing device 106 may have switches 115 that may be activated by applying a force to the user-interface device 112. For example, the user-interface device 112 may be connected to a selection switch 115A, which may be activated by depressing and releasing the user-interface device 112 in the direction indicated by the arrow 90. By depressing the user-interface device 112 to provide a selection, a signal may be sent to the microprocessor 109 indicating the user's desire to select something, for example to select a pinyin-character candidate, pinyin-group candidate or ideographic character.

The user-interface device 112 may also include one or more movement switches 115B. In FIG. 2, the movement switches 115B for indicating a force applied in the westerly “W” direction and an easterly “E” direction are shown. Additional movement switches 115B may be provided for indicating a force applied in the northerly “N” direction and a southerly “S” direction. The movement switch 115B may be used to indicate the user's desire to move a cursor 87 on the display 103, or to move from one level of information to another, or effect some other change on the display 103. By applying a force to the user-interface device 112 that does not result in depressing the user-interface device 112, the user may be able to activate the movement switches 115B. Activation of the movement switch 115B may send a signal to the microprocessor 109 indicating the user's desire to cause a change on the display 103. In response, the microprocessor 109 may cause the display 103 to be altered in keeping with the signal from the movement switch 115B, for example the cursor 87 may be moved.

The force applied to the user-interface device 112 to activate a movement switch 115B may be applied in one of a plurality of cardinal directions, each cardinal direction indicating a different type of movement. For example, applying a force to the user-interface device 112 in a westerly “W” cardinal direction may cause the microprocessor 109 to move the cursor 87 to the left on the display 103, whereas applying a force in an easterly “E” cardinal direction to the user-interface device 112 may cause the microprocessor 109 to move the cursor 87 to the right on the display 103.

Applying a force in a northerly “N” cardinal direction, the microprocessor 109 may cause the display 103 to provide a shallower level of information. For example, if the display 103 is providing pinyin-group candidates, the user may apply a force to the user-interface device 112 in a northerly cardinal direction to indicate a desire to have pinyin-character candidates displayed.

Applying a force in a southerly “S” cardinal direction to the user-interface device 112 may send a signal to the microprocessor 109 indicating the user's desire to have provided via the display 103 a deeper level of information. For example, if the user desires viewing of pinyin-group candidates corresponding to the pinyin character “B”, the user may move the cursor 87 so as to highlight the “B” and then apply a southerly force to the user-interface device 112. In response, the microprocessor 109 may cause the display 103 to provide the pinyin-group candidates “BAI”, “BAN”, “BANG”, “BAO” and “BA”.

When using a continuous navigation device for the user-interface, such as a trackball, displacement of the user-interface device 112 need not be to the full extent of its travel in order to constitute a positive switch indication, and the threshold at which this switching might occur can be varied so as to suit the user. For example, 25% displacement can be used to determine one intended action, and other displacement thresholds may be used to indicate other actions desired by the user. Additional switching thresholds can be formulated so that it is possible to navigate through levels of detail by continued action rather than having to return to a mechanical center position.

Further, the resolution of the user-interface device 112 need not be limited to only two selection switch conditions. Depressing the user-interface device 112 may occur so as to have two or more points along the direction of travel in order to allow the user to signal different desires. In addition, it is possible to have more cardinal directions—for example, instead of having merely four cardinal directions, North, South, East and West, additional cardinal positions may include North-East, North-West, South-West and South-East. Also, in the embodiment using a joy stick, it may be possible to provide additional control by including switches sensitive to twisting of the joystick—for example, by twisting the joystick, the information provided on the display may be scrolled to reveal hidden candidates, characters or groups.

Beyond even this, once “vertical” pressure has been used to indicate that a selection action has taken place, a user-interface device 112 such as a trackball need not be returned to its starting point mechanically. Instead, the user may simply release the vertical pressure and the appliance electronically may reset the trackball. In this way, user effort may be reduced and the appliance is made easier to use.

The invention may be embodied as a computer readable memory device 200. For example, the memory device 200 may be a flash memory or a compact disc. On the memory device 200 may be instructions 203 that are executable by a computer, such as the microprocessor 109. The memory device 200 may be provided to a reader 206, which is capable of reading the instructions 103 on the memory device 200. The instructions 203 may cause a computer to execute a method according to the invention. For example, the instructions 203 may cause a computer to (a) provide a first list of pinyin-character candidates, (b) receive a selection signal indicating one of the pinyin-character candidates from the first list, (c) provide a second list of pinyin-group candidates, each pinyin-group candidate starting with the selected pinyin-character, (d) receive a selection signal indicating one of the pinyin-group candidates from the second list, and (e) provide an ideographic character associated with the desired pinyin-group. The memory device 200 may also include instructions 203 that are capable of causing a computer to receive a selection signal indicating selection of the ideographic character.

As noted above, at least one of the pinyin-group candidates may also be found on the first list of pinyin-character candidates. Some or all of the pinyin-group candidates may be comprised of at least two pinyin characters. Pinyin-character candidates, pinyin-group candidates and/or ideographic characters may be provided in an order that places the most likely desired candidates toward the first part of the list. For example, the order may be based on previously entered text.

U.S. provisional patent application No. 60/632,370 discloses additional details about the invention and additional embodiments of the invention. The disclosure of that patent application is incorporated by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of using a pointing device to identify an ideographic character, comprising:
providing an appliance having a pointing device and a display;
providing on the display a first list of pinyin-character candidates;
selecting a first pinyin character from the first list using the pointing device;
providing on the display a second list, the second list being comprised of pinyin-group candidates, each pinyin-group candidate starting with the first pinyin character;
selecting a desired pinyin-group from the second list;
providing on the display an ideographic character associated with the desired pinyin-group.

2. The method of claim 1, wherein at least one of the pinyin-group candidates is also found on the first list of pinyin-character candidates.

3. The method of claim 1, wherein at least one of the pinyin-group candidates is comprised of at least two pinyin characters.

4. The method of claim 1 wherein pinyin-character candidates are presented in likelihood order.

5. The method of claim 4, wherein the order of the pinyin-character candidates is based on previously entered text.

6. The method of claim 1, wherein ideographic candidates are presented in likelihood order.

7. The method of claim 6, wherein the order of the ideographic candidates is based on previously entered text.

8. The method of claim 1, wherein display order of candidates is prioritized so as to display phrase completion candidates, word completion candidates and single unassociated candidates in groups.

9. The method of claim 1, wherein selecting a first pinyin character is accomplished by pressing the pointing device.

10. The method of claim 1, further comprising selecting the ideographic character.

11. A selection device, comprising:
a display;
a pointing device;
a microprocessor in communication with the pointing device and the display, the microprocessor being programmed to (a) provide via the display a first list of pinyin-character candidates, (b) receive a first selection from the pointing device, the first selection being one of the pinyin-character candidates, (c) provide via the display a second list, the second list indicating comprised of pinyin-group candidates, each pinyin-group candidate starting with the first selection, (d) receive a second selection from the pointing device, the second selection indicating one of the pinyin-group candidates; (e) providing via the display an ideographic character associated with the selected pinyin-group.

12. The selection device of claim 11, wherein the pointing device includes a track ball.

13. The selection device of claim 11, wherein the pointing device includes a joystick.

14. The selection device of claim 11, wherein the pointing device includes a selection switch, which is activated by depressing the pointing device.

15. The selection device of claim 11, wherein the pointing device includes a movement switch, which is activated by applying a force to the pointing device without depressing the pointing device.

16. The selection device of claim 15, wherein the force may be applied in one of a plurality of cardinal directions, each cardinal direction indicating a different type of movement.

17. The selection device of claim 15, wherein activation of the movement switch causes the microprocessor to effect a change on the display.

18. The selection device of claim 17, wherein activation of the movement switch in a northerly cardinal direction causes the microprocessor to provide via the display a shallower level of information.

19. The selection device of claim 17, wherein activation of the movement switch in a southerly cardinal direction causes the microprocessor to provide via the display a deeper level of information.

20. The selection device of claim 17, wherein activation of the movement switch in a westerly cardinal direction causes the microprocessor to move via the display a cursor to the left.

21. The selection device of claim 17, wherein activation of the movement switch in a easterly cardinal direction causes the microprocessor to move via the display a cursor to the right.

22. A computer readable memory device having stored thereon instructions that are executable by a computer, the instructions being capable of causing a computer to (a) provide a first list of pinyin-character candidates, (b) receive a selection signal indicating one of the pinyin-character candidates from the first list, (c) provide a second list of pinyin-group candidates, each pinyin-group candidate starting with the selected pinyin-character, (d) receive a selection signal indicating one of the pinyin-group candidates from the second list, and (e) provide an ideographic character associated with the desired pinyin-group.

23. The memory device of claim 22, wherein at least one of the pinyin-group candidates is also found on the first list of pinyin-character candidates.

24. The memory device of claim 22, further comprising instructions capable of causing a computer to receive a selection signal indicating selection of the ideographic character.
